(19) United States
(12) Patent Application Publication
(10) Pub. No.: US 2009/0025532 A1
(43) Pub. Date: Jan. 29, 2009

(54) Drum

(76) Inventor: Shih-Ying Lu, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,329

(22) Filed: Jul. 24, 2007

(51) Int. Cl. G10D 13/02

(52) U.S. Cl. 84/413

(57) ABSTRACT

A drum includes a shell, a counterhoop and a head. The shell is cylindrical and provided with a combining member to engage with an engaging member of the counterhoop, and the head is sandwiched tightly between the shell and the counterhoop, with no need of any other parts to keep the head stretched tight so as to save time and cost for its manufacture.

### BACKGROUND OF THE INVENTION

1. Field of the Invention

This invention relates to a drum, particularly to one provided with a counterhoop for stretching a head, without any need of using any other parts, saving time and cost for manufacturing.

2. Description of the Prior Art

Repercussions instruments have historically been used more than 3,000 years in the festivals and grand events. Especially gongs and drums have been the most popular of the traditional musical instruments in China, used widely at new years to give rise to happy and animated atmosphere in the social activities. As for drums, nowadays there are many kinds, such as bass drums, snare drums, conga drums, etc. and recently a set of various drums of small and large sizes used for making different sounds with two drumsticks and beating different locations of the head. If the center of the head is hit it may sound out comparatively deep-toned and long sound, and if the location hit goes nearer to the outer circumference of the head, the rumbling sound grows higher-toned. The aforesaid drum is provided with a drum body of a hollow shape and a head stretched at an upper surface of the drum body. The head has a plastic substrate with an upper surface formed with a plurality of projecting light grid strips and a lower surface printed with patterns, and plural strong tension rods fixed on an outer side of the shell for adjusting the tension of the head for producing different toned sounds when beaten.

However, the drum of this Taiwan patent is provided with plural strong tension rods for stretching the head tightly, increasing its manufacturing cost because of comparatively long time and much work required in its production.

### SUMMARY OF THE INVENTION

The feature of a drum in the invention is a shell, a counterhoop and a head. The shell is provided with a frame at an upper end and at a lower side, and the frame is provided with a combining member in an outer surface to engage with an engaging member of the counterhoop, which has a folded member extending inward at an upper side or at a lower end. Then the head is kept sandwiched between the frame of the shell and the folded member of the counterhoop, with no need of any other parts for keeping the head in its position, thus saving time and cost in manufacturing.

### BRIEF DESCRIPTION OF DRAWINGS

This invention will be better understood by referring to the accompanying drawings, wherein:

FIG. 1 is an exploded perspective view of a drum in the present invention;

FIG. 2 is a perspective view of the drum in the present invention;

FIG. 3 is a side cross-sectional view of the drum in the present invention;

FIG. 4 is a partial cross-sectional view of the drum in the present invention; and,

FIG. 5 is a partial cross-sectional view of the drum being used in the present invention.

### DETAILED DESCRIPTION OF THE PREFERRED EMBODIMENT

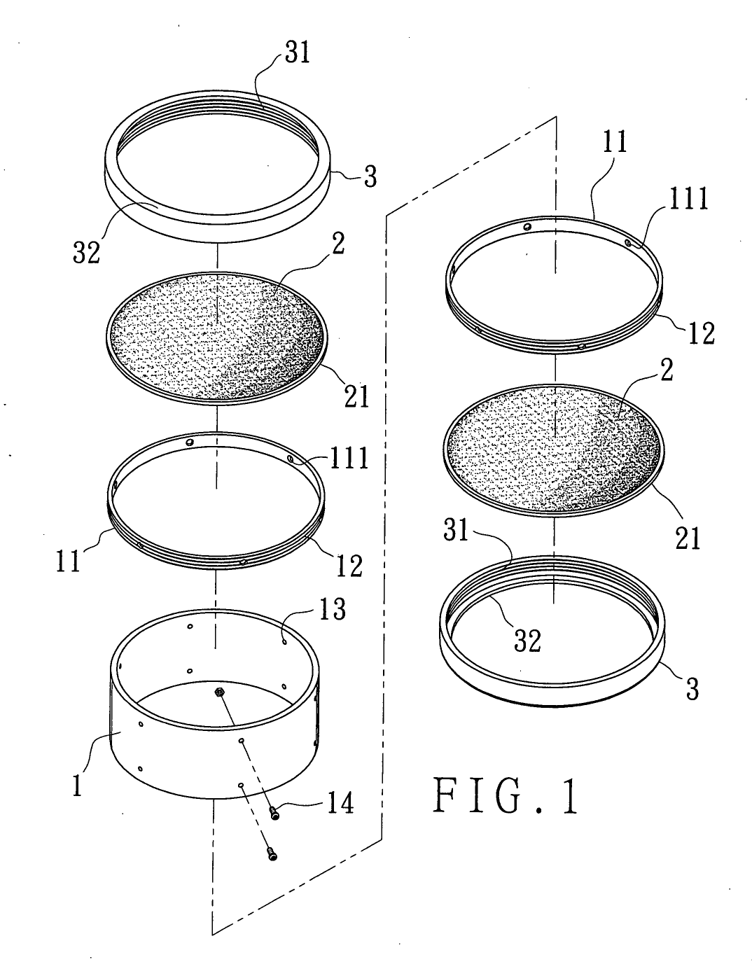

A preferred embodiment of a drum in the present invention, as shown in FIG. 1, includes a shell 1, plural heads 2 and plural counterhoops 3 as main components combined together.

The shell 1 is cylindrical, having a frame 11 respectively provided at an upper end and a lower end, and plural threaded holes 13 spaced apart equidistantly. The frame 11 is provided with a combining member 12 such as male threads and plural threaded holes 111 to correspond to the threaded holes 13 of the shell 1 for screws to engage with for combining stably the frame 11 with the shell 1.

The head 2 is provided with a head collar 21 fixed around its outer circumference so as to be fixed with the shell 1.

The counterhoop 3 is provided with an engaging member 31 such as female threads to engage with the combining members 12 of the shell 1 and a folded member 32 formed to extend inward from a lower end or an upper end.

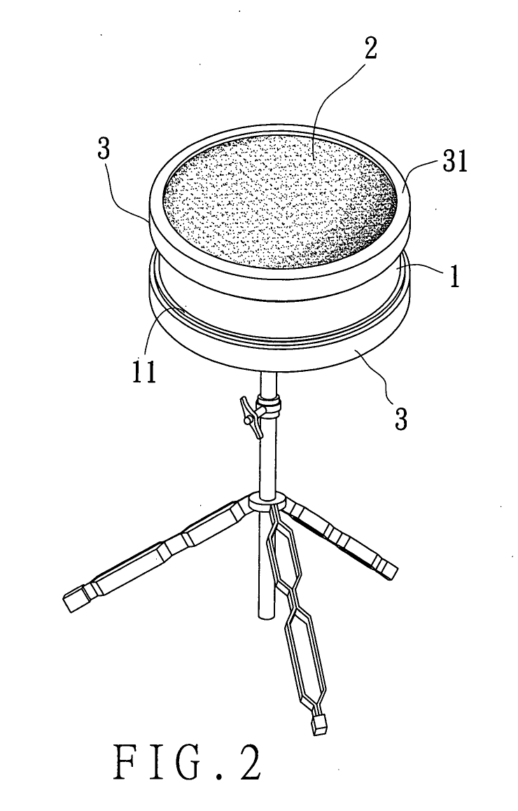

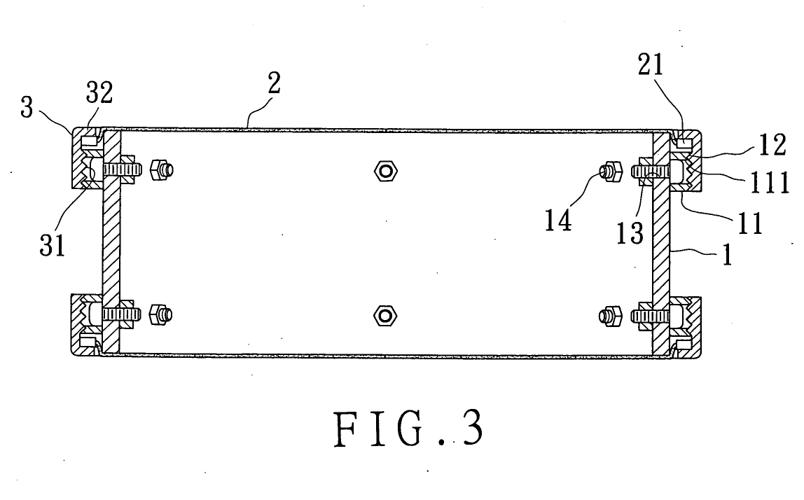

In assembling, as shown in FIGS. 2, 3 and 4, firstly, the head 2 is respectively covered on the upper side and the lower side of the shell 1, with the head collar 1 located at an outer circumference of the shell 1. Then the folded member 32 of the counterhoop 3 is just positioned to locate on the head collar 21, with the engaging member 31 engaging tightly with the combining members 12 of the shell 1 and with the folding member 32 compressing the head collar 21 of the head 2 between the counterhoop 3 and the shell 1, with no need of any other components for keeping the head 2 stretched tight. Therefore, the whole shell 1 is not hidden by any means, looking neat and decent, and the head 2 is kept pressed stably by the counterhoop 3 so that the tension of the head 2 is well balanced to produce comparatively pleasing rumbling sound.

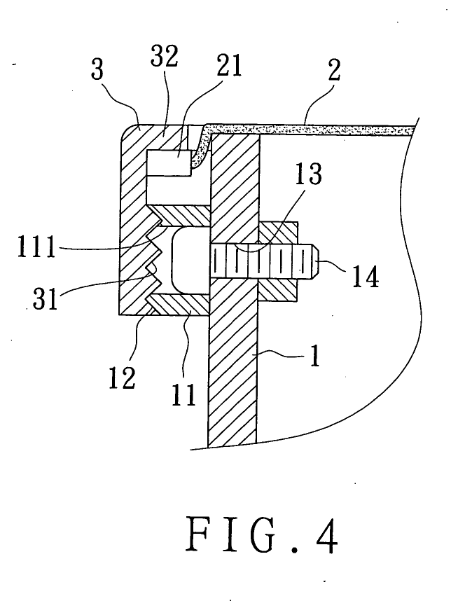

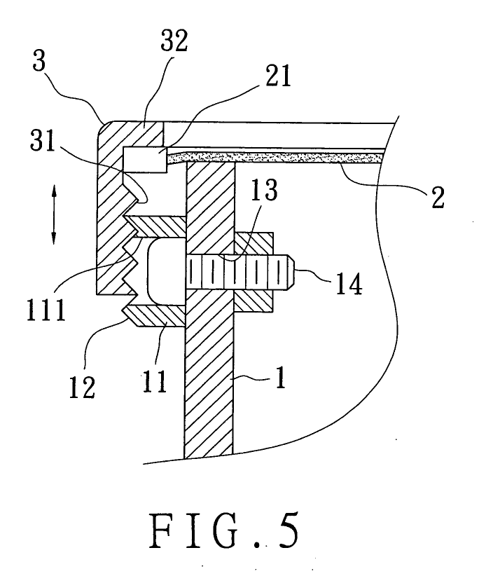

In using, as shown in FIGS. 4 and 5, at first, the engaging member 31 of the counterhoop 3 is turned to move down or up, altering properly the tension of the head 2 so that the sound of the head 2 may be adjusted to change accordingly. If the head 2 is to be replaced with a new one, the head 2 with the head collar 21 can be taken off the shell 1 after the counterhoop 3 is removed off the shell 1. After the new head 2 is placed properly on the shell, the counterhoop 3 is fitted tightly on the head 2 again.

The invention has the following advantages as can be seen from the foresaid description.

1. It has the counterhoop to sandwich stably the head between itself and the shell, with no need of any other means, saving time and cost for manufacture.

2. The whole shell is not hidden by any other parts, looking neat and decent.

3. The head is compressed tightly by means of the counterhoop, so the surface tension of the head is well balanced, able to give out good sound when beaten by a user.

4. The counterhoop can be turned to move up and down relative to the head so that the tension of the head may be altered to enable the produced sound of the head to change for convenience of use.

5. Taking off the counterhoop from the shell enables the head to be replaced with a new one, which can be easily set stable again by the counterhoop

While the preferred embodiment of the invention has been described, it will be recognized and understood that various modifications may be made therein and the appended claims are intended to cover all such modifications that may fall in the spirit and scope of the invention.

What is claimed is:

1. A drum comprising a shell, said shell provided with a combining member, a counterhoop provided with an engaging member to combine with said combining member, a head sandwiched between said shell and said counterhoop.

2. The drum as claimed in claim 1, wherein said shell is provided with a frame, and said frame is provided with a combining member.

3. The drum as claimed in claim 2, wherein said shell and said counterhoop both are provided with plural threaded holes to correspond to one another for screws to engage with for combining said shell tightly with said counterhoop.

4. The drum as claimed in claim 1, wherein said combining member and said engaging member are threads.

5. The drum as claimed in claim 1, wherein said head is provided with a head collar fixed around its outer circumference, and said head collar is sandwiched between said shell and said counterhoop.

6. The drum as claimed in claim 1, wherein said counterhoop is provided with a folded member extending inward from an upper end to compress said head.
